(19) United States
(12) Patent Application Publication
(10) Pub. No.: US 2015/0048951 A1
(43) Pub. Date: Feb. 19, 2015

(54) PORCH LIGHT

(71) Applicant: Kevin Chesney, Stoney Creek (CA)

(72) Inventor: Kevin Chesney, Stoney Creek (CA)

(21) Appl. No.: 14/463,079

(22) Filed: Aug. 19, 2014

Related U.S. Application Data
(60) Provisional application No. 61/867,332, filed on Aug. 19, 2013.

(51) Int. Cl. G08B 17/103

(52) U.S. Cl. CPC G08B 17/103
USPC 340/628

(57) ABSTRACT

A porch light assembly with an emergency signaling device is disclosed. The emergency signaling device is in the form of a strobe light associated with a porch light, the strobe light being in communication with one or more smoke detectors installed within the building or residence. The strobe light can be mounted integrally within the mounting base of the lighting fixture itself or a separate mounting base with strobe light can be attached to a separate lighting fixture. The strobe light can be hardwired to the same electrical circuit operating the smoke detectors or can be connected wirelessly with the smoke detectors. Upon activation, the strobe light provides a visual emergency signal on the exterior of the building or residence allowing emergency crews to quickly and easily identify the building or residence in need of assistance.

### TECHNICAL FIELD

The invention relates to a porch or coach light assembly with an emergency activated signaling device, in particular a strobe light, for mounting on the exterior of a building or residence to assist emergency services in identifying a particular building in need of assistance.

### BACKGROUND

When emergency services, such as fire crews, are called to a building or structure such as a business or residence, etc., it can be difficult to locate the specific building or structure that is in need of assistance on a particular street. During the evening or night-time hours this problem can be exacerbated due to the lack of sunlight or natural light during evening hours, as well as due to poor lighting of doorways or entrances of buildings or residences to allow for quick and easy visual identification of the particular address of the building.

It is not uncommon for businesses or private residences to have porch or coach lights or other lighting means associated with the doorways or entrances to the buildings, but standard coach lights do not necessarily provide sufficient lighting in order to easily and quickly identify the specific address of the building. In situations where emergency assistance is required, i.e. from fire department or police department, etc. the ability to quickly and easily identify the particular building or residence in need of assistance is advantageous in that emergency crews can arrive at the scene without undue delay.

An emergency signaling device that allows for easy identification by emergency services crews of a particular building or residence in need of assistance is, therefore, useful in such instances.

### SUMMARY OF PRESENT DISCLOSURE

In accordance with an exemplary embodiment of the present disclosure there is provided a porch light assembly for mounting exterior to a building or residence having at least one smoke detector installed therein, the porch light assembly comprising a lighting fixture; a mounting base having a first surface for receiving said lighting fixture and a second surface, the second surface being a mounting surface; a strobe light mounted within said mounting base and visible from the first surface of said mounting base; a first electrical connection for operating said lighting fixture; and a second electrical connection for operating said strobe light; wherein said second electrical connection is operably coupled to said at least one smoke detector, the strobe light being activated upon activation of said at least one smoke detector.

In accordance with another exemplary embodiment of the present disclosure there is provided a mounting base for a porch light having a lighting fixture and a mounting portion for use exterior to a building or residence having at least one smoke detector installed therein, the mounting base comprising a body having a first surface for receiving and engaging the mounting portion of said porch light and a second surface for mounting to a surface exterior to a building or residence; a first opening formed in said body; a second opening formed in said body; a strobe light device mounted within said second opening and visible on said first surface; an electrical box mounted within said first opening for receiving electrical components associated with said lighting fixture and said strobe light.

In accordance with another exemplary embodiment of the present disclosure there is provided a kit for a porch light assembly with an emergency signaling device, comprising at least one smoke detector adapted for installation within a building or residence; a mounting base having a first surface for receiving a lighting fixture and a second mounting surface; a strobe light mounted within said mounting base and visible from the first surface; wherein the mounting base provides a first electrical connection in communication with said lighting fixture, said first electrical connection adapted to connect to an electrical system within said building or residence; and a second electrical connection in communication with said at least one smoke detector and operably coupled to said strobe light.

In accordance with yet another exemplary embodiment of the present disclosure there is provided a system for identifying a building or residence in need of emergency assistance, comprising at least one smoke detector operably installed within a building or residence; an exterior porch light assembly mounted exterior to and in relation to said building or residence; a strobe light device connected to said exterior porch light, the strobe light device being operably coupled to said at least one smoke detector, the strobe light being activated simultaneously upon activation of said at least one smoke detector.

### BRIEF DESCRIPTION OF THE DRAWINGS

Exemplary embodiments of the present disclosure will now be described by way of example with reference to the accompanying drawings, in which:

FIG. 1 is a perspective view of a porch light assembly according to an example embodiment of the present disclosure;

FIG. 2 is a front elevation view of the porch light assembly of FIG. 1;

FIG. 3 is a side elevation view of the porch light assembly of FIG. 1;

FIG. 4 is a perspective view of a mounting base for the porch light assembly of FIG. 1;

FIG. 5 is a front elevation view of the mounting base of FIG. 4;

FIG. 6 is a side perspective view of the mounting base of FIG. 4;

FIG. 7 is a front perspective view of a porch light assembly according to an alternate embodiment of the present disclosure;

FIG. 8 is a front elevation view of the porch light assembly of FIG. 7,

FIG. 9 is a side elevation view of the porch light assembly of FIG. 7;

FIG. 10 is a rear perspective view of the porch light assembly of FIG. 7;

FIG. 10A is a side elevation view of the porch light assembly of FIG. 7 shown in an alternate position;

FIG. 11 is a front perspective view of a porch light assembly according to another alternate embodiment of the present disclosure;

FIG. 12 is a side elevation view of the porch light assembly of FIG. 11;

FIG. 13 is a rear perspective view of the porch light assembly of FIG. 11;

FIG. 14 is a schematic diagram illustrating the operation of the porch light assembly according to an exemplary embodiment of the present disclosure; and

FIG. 15 is a schematic diagram illustrating the operation of the porch light accordingly to another exemplary embodiment of the present disclosure.

FIG. 16 is a front perspective view of a porch light assembly of FIG. 4, affixed to a wall.

FIG. 17 is a front perspective view of a porch light assembly of FIG. 4, shown in isolation but affixed to a standard octagonal electrical box, which would typically be found within a wall.

FIG. 18 is a top perspective view of a retrofit adapter which fits between a standard smoke detector and a standard smoke detector socket to allow the standard smoke detector to communicate with a porch light assembly of the present invention.

FIG. 19 is a bottom perspective view of the retrofit adapter of FIG. 17.

FIG. 20 is a top perspective view of an alternate configuration of a retrofit adapter, wherein the retrofit adapter is also a wiring harness.

### DETAILED DESCRIPTION OF EXEMPLARY EMBODIMENTS

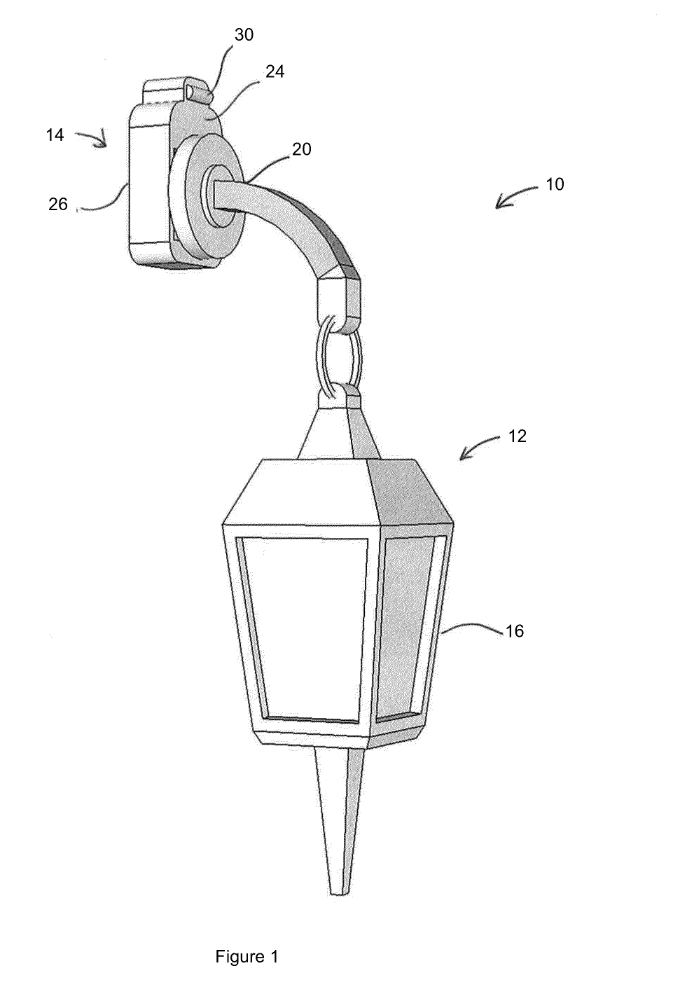

Referring now to FIG. 1, there is shown a porch light assembly 10 with an emergency signaling device according to an example embodiment of the present disclosure. The porch light assembly 10 includes a lighting fixture 12 for mounting on the exterior of a building or private residence and a separate mounting base 14. The lighting fixture 12 comprises a generally decorative housing 16 for housing a lighting device (not shown) such as an incandescent light bulb or any other suitable lighting means, the housing 16 being supported by a mounting portion 20 typically for mounting the lighting fixture 12 to an exterior wall or other suitable surface exterior of a building or residence when the lighting fixture 12 is used independently of mounting base 14. While an exemplary lighting fixture 12 in the form of a downwardly depending porch light that is suspended from mounting portion 20 is illustrated in the drawings, it will be understood that the lighting fixture 12 is not limited to the particular decorative porch light shown in the drawings and that any exterior lighting fixture 12 or coach light may be used in conjunction with mounting base 14.

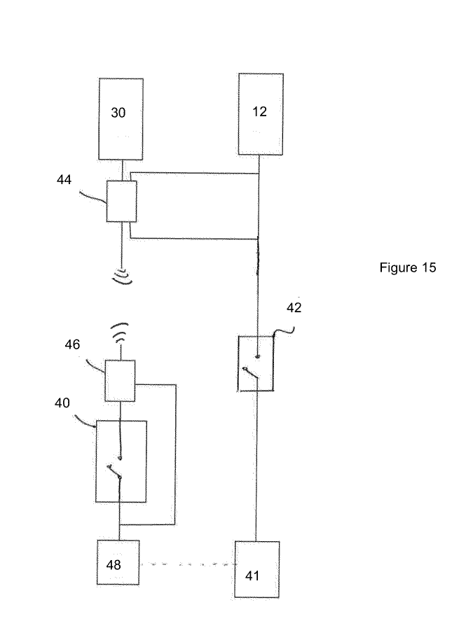

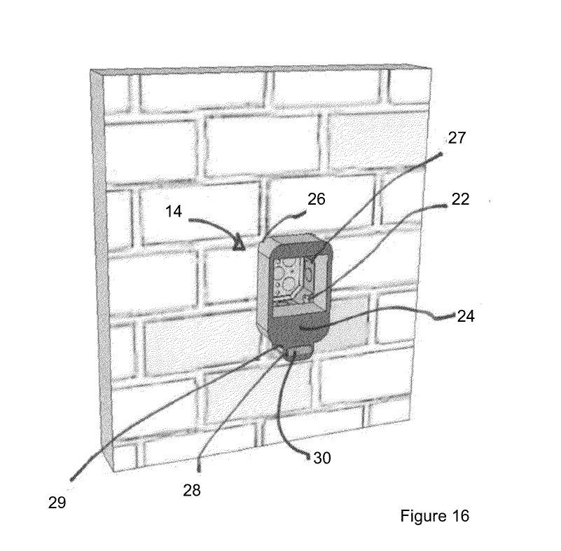

In the subject exemplary embodiment, mounting base 14 is separate to the lighting fixture 12 and is generally in the form of a rectangular-shaped body having a first or central opening 22 formed therein. The mounting base 14 has a front or first surface 24 and a rear or second surface 26 directly opposed to the first surface 24, the central opening 22 extending through the mounting base 14 from the first surface 24 through to the second surface 26. The first surface 24 of the mounting base 14 is adapted for receiving and engaging with the mounting portion 20 of the lighting fixture 12, the second surface 26 adapted for mounting to the exterior wall of other exterior surface (not shown) associated with the building or residence. Central opening 22 is adapted to receive any suitable standard electrical box 27, such as a standard octagon box, for housing the electrical wiring and/or electrical components associated with the lighting fixture 12. As shown for example in FIGS. 16 and 17, the central opening 22 can be affixed to a standard octagon box (electrical box 27) through the standard bolt pattern used in the industry, for example, utilizing a universal circular or cross-shaped adapter. By having the central opening 22 extend through the body of the mounting base 14, the electrical wiring and/or components housed within the standard electrical box 27 are easily accessible from the rear or second surface 26 of the mounting base 14 allowing the mounting base 14 with lighting fixture 12 to be easily and conveniently connected to the electrical system of the building or residence Accordingly, in use, the lighting fixture 12 is electrically connected to the electrical system of the building or residence through the rear or second surface 26 of the mounting base 14 while the mounting portion 20 of the lighting fixture 12 is secured to the first surface 24 of the mounting base 14 over top of the central opening 22. The mounting base 14, itself, is then used to secure the entire porch light assembly 10 to an exterior surface associated with the exterior of the building or residence.

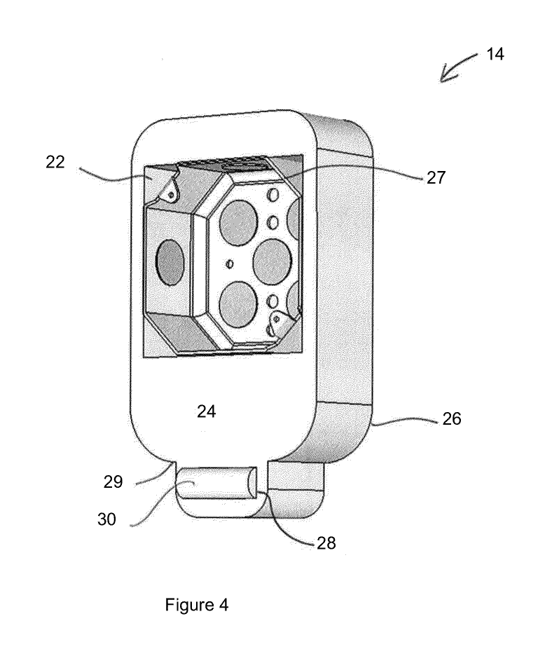

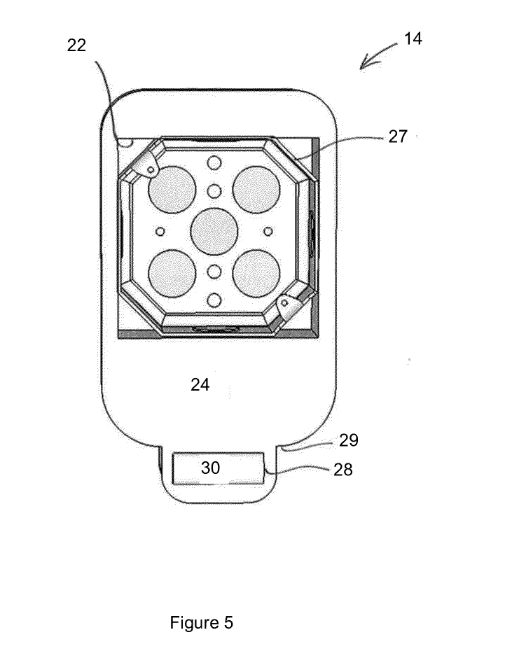

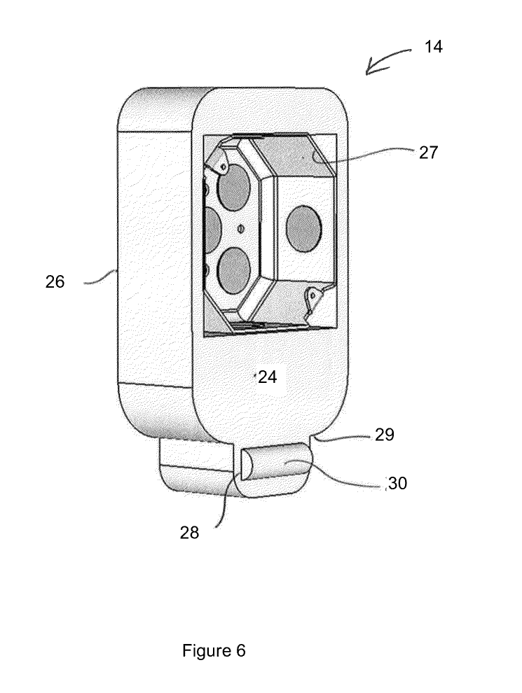

Referring now to FIGS. 4-6, the mounting base 14 is provided with a second opening 28, the second opening 28 being in the form of a frame that projects or extends outwardly beyond the footprint of the mounting base 14. The second opening 28 is integrally formed as part of the mounting base 14 and, as shown, extends or projects outwardly from a peripheral edge portion 29 of the mounting base 14. It will be understood, however, that the second opening 28 may also be formed within the footprint of the mounting base 14 defined by the peripheral edge 29 and that the second opening 28 does not necessarily need to project outwardly from the peripheral edge 29 of the mounting base 14.

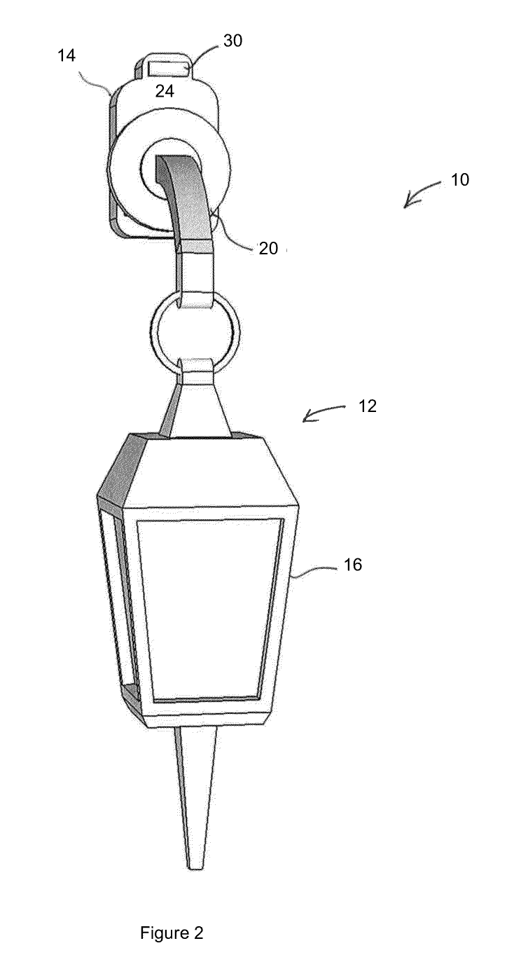

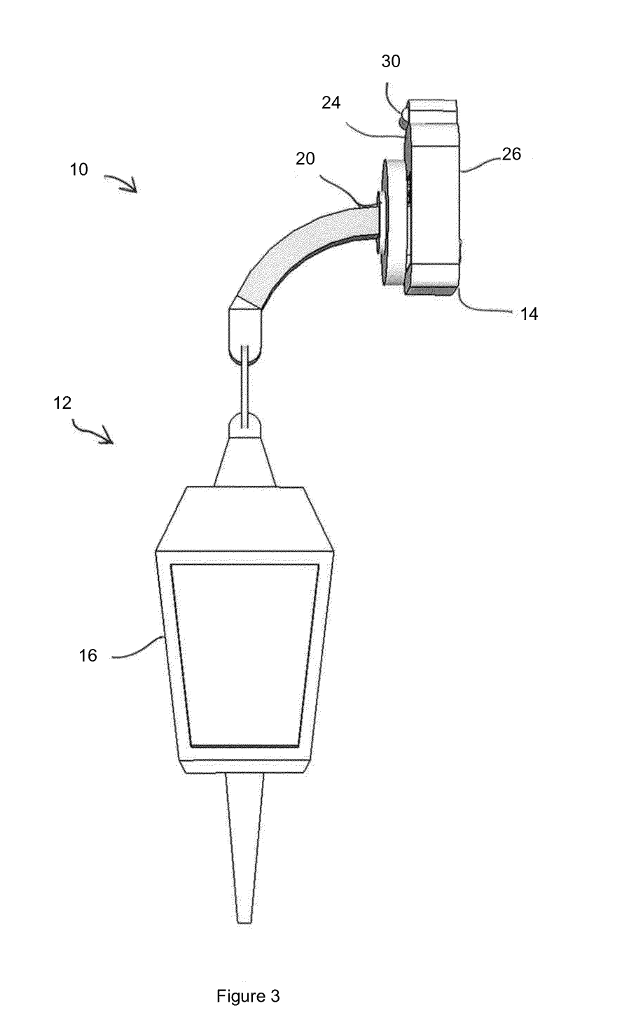

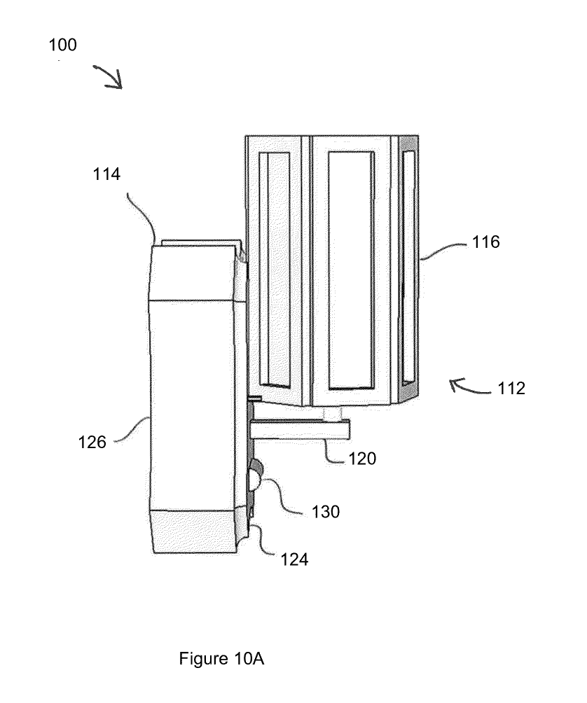

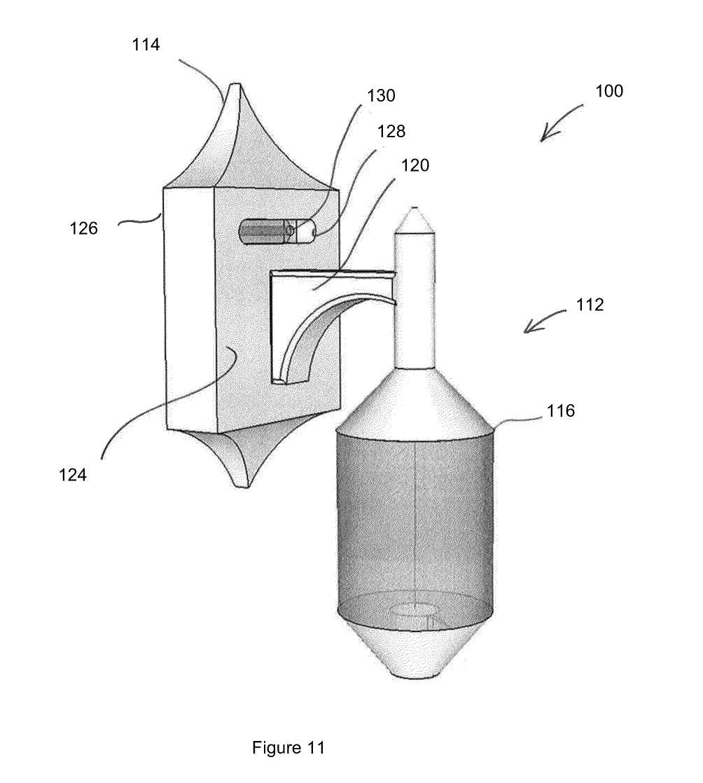

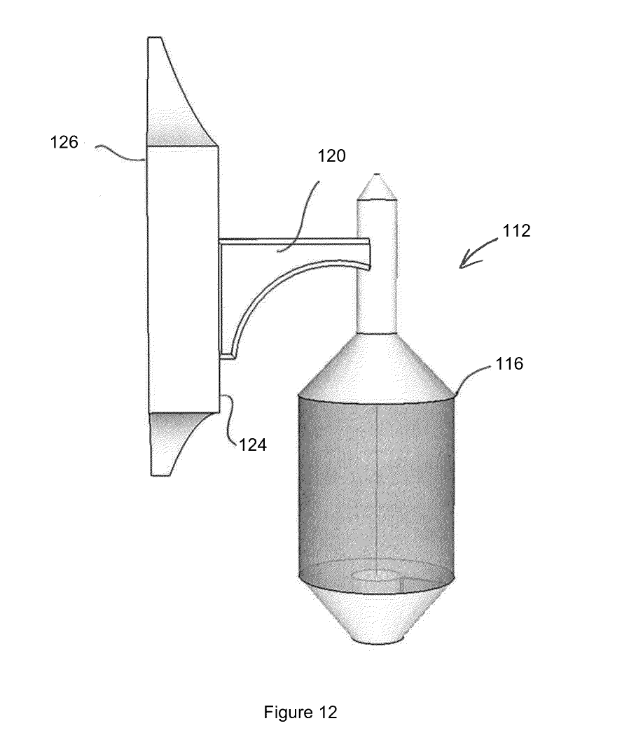

A strobe light 30 is mounted within the second opening 28 in such a manner that it is visible from the first or front surface 22 of the mounting base 14. The strobe light 30 may be in the form of a xenon flash tube or an LED bulb type or any other suitable strobe light device known in the art. Depending upon the type of strobe light device that is used, the strobe light 30 may project out of the first or front surface 24 of the mounting base 14, as shown in FIGS. 1-6 for example, or may instead be flush with or recessed within the front surface 24 (for instance as shown in the exemplary embodiment of FIGS. 11-13). Any wiring associated with the strobe light 30 can be fed through or directed to the central opening 22 within the mounting base 14 so that all of the wiring and/or electrical components are housed within the electrical box 27.

When mounting the porch light assembly, the mounting base 14 can be oriented so that the strobe light 30 is arranged at the bottom or lower portion of the mounting base 14 so as to project downwardly away from the lower peripheral edge 29 of the mounting base 14, as shown in FIGS. 4-6. This arrangement is particularly useful when the lighting fixture 12 extends upwardly from the mounting portion 20 so that the strobe light 30 is not obscured from view by the lighting fixture 12. The mounting base 14 can also be rotated 180 degrees and oriented so that the strobe light 30 is at the top or upper portion of the mounting base 14 in relation to the lighting fixture 12, as shown in FIGS. 1-3. This arrangement is particularly useful when the lighting fixture 12 is downwardly depending with respect to the mounting portion 20, as shown in FIG. 1-3, to ensure that the strobe light 30 remains visible and un-obscured by the lighting fixture 12 when the entire porch light assembly 10 is installed.

While the mounting base 14 has been shown as being arranged so that the strobe light 30 is either at the top or bottom of the mounting base 14, it will be understood that the mounting base 14 can also be positioned so that the strobe light 30 is arranged to one side of the lighting fixture 12. More specifically, it will be understood that the key to the positioning the mounting base 14 and strobe light 30 with respect to the lighting fixture 12 is that the strobe light 30 must be clearly visible and un-obstructed by the lighting fixture 12 when the entire porch light assembly 10 is installed. By providing a mounting base 14 with strobe light 30 that is separate to the lighting fixture 12 allows for any suitable lighting fixture 12 to be adapted to include an emergency signaling device in the form of a strobe light 30 and also provides a degree of flexibility and/or adjustability in that the mounting base 14 can be arranged in a variety of positions to ensure that the strobe light 30 is clearly visible on the exterior of the building or residence.

For a private residence, business or other building equipped with smoke detectors 40, the porch light assembly 10 is installed exterior to the building in such a manner that the strobe light 30 is powered through a separate circuit to that which powers the lighting fixture 12 itself, the strobe light 30 being activated when one or more of the smoke detectors 40 are activated. Accordingly, when one or more of the smoke detectors 40 installed within the building or residence are in an alarm state or condition, the strobe light 30 also becomes activated thereby providing a visual emergency signal on the exterior of the building that allows emergency crews to quickly and easily identify the building in need of assistance.

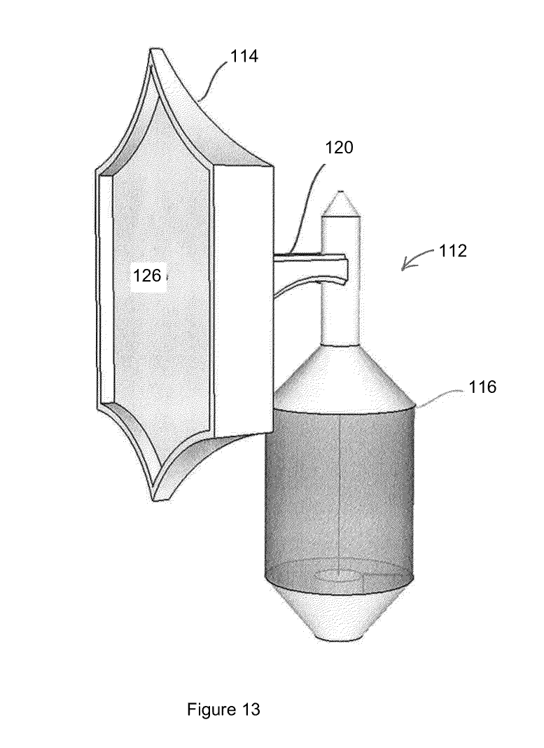

Accordingly, when the smoke detectors 40 installed within a building or residence are hardwired into the electrical system 41 of the building in accordance with principles know in the art, the porch light assembly 10 is installed so that the lighting fixture 12 is powered by the hot and neutral lines of the electrical system, while the strobe light 32 is powered by the same circuit that interconnects the individual smoke or heat detectors 40 within the home or building, the strobe light 30 therefore being powered by the red line within the smoke detector or alarm circuit. A diagram illustrating the operation of the strobe light 30 is shown schematically in FIG. 14. This allows the lighting fixture 12 to be turned on and off as desired, independently of the strobe light 30, generally by a switch 42, the strobe light 30 generally only being activated when one or more of the smoke detectors or alarms is/are activated. The strobe light 30 may also be provided with a manual override 43 in the form of an on/off switch that is independent from the on/off switch 42 associated with the lighting fixture 12, the manual override 43 allowing the strobe light 30 to be activated even if there is no alarm state or condition. While only three smoke detectors or alarms 40 have been shown in FIG. 14, it will be understood that this is intended to be illustrative and that the system may be equipped with any number of smoke detectors 40. In systems with a manual override 43, it is desirable that the manual override 43 is in the form of a switch that is easily differentiable from a standard wall switch. For example, manual override 43 can be of a different colour, and can light up or flash when activated.

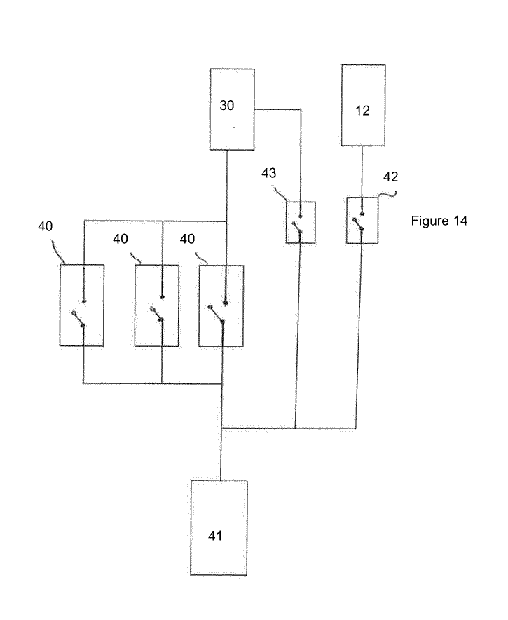

Alternatively, the mounting base 14 may be provided with a wireless receiving device 44 that is operatively coupled to the strobe light 30, as shown schematically in FIG. 15. One or more compatible smoke detectors 40 (only one shown in FIG. 15 for illustrative purposes) equipped with a transmitting device 46 for transmitting a signal to the wireless receiving device 44 within the mounting base 14 is/are installed within the building or residence when the smoke detector 40 is activated. The smoke detector 40 and/or transmitting device 46 can be hardwired into the electrical system 41 of the building or residence or the smoke detector 42 with transmitting device 44 can be powered independently from a separate power source 48, for instance a battery. When an alarm condition is triggered by one or more smoke detectors 40 within the building or residence, the transmitting device 46 generates a signal that is received by the wireless receiving device 44 that forms part of the mounting base 14 thereby activating the strobe light 30. The receiving device 44 in mounting base 14 can be powered by means of a rechargable battery (not shown) that receives a charge from the lighting fixture 12 when the lighting fixture 12 is turned “ON”. Therefore, every evening when the lighting fixture 12 is turned “ON” to illuminate the exterior of the building or residence, the battery that powers the wireless receiving device 44 receives a charge to ensure that it is operational if and when an alarm condition occurs. In the case of a wireless system, the system may optionally also be configured with a wireless switch, similar to the hard wired manual override 43 as described above, but communicating wirelessly with the strobe light 30. As would be appreciated, ideally, in a wireless application, it is desirable that the addition of the strobe light 30 and the wireless system in general, including such a manual override 43, require the least modification possible to the existing wiring and architecture; as such, it is desirable that the wireless manual override 43 on/off switch and the on/off switch 42 for turning on lighting fixture 12 be configured in the same switch box, of a standard size. In this manner, it is unnecessary to install a new electrical box for the added wireless manual override 43. The strobe light wireless switch 42 can be powered through the standard wall switch power supply, or can be powered through a user-replaceable battery. In embodiments where the wireless switch is powered through the standard wall switch power supply, it is desirable to have a battery back-up, so that the switch can be used and is able of sending a signal to the strobe light 30 even in the case of a power failure.

In the case of a wireless system as herebefore described, it can be desirable to provide such a system with a unique and/or programmable code, which is utilized when signals are sent to the strobe light 30. Such a code can be programmable utilizing any method known in the art, such as a set of DIN switches on the wireless components (transmitting device 46 and, where utilized, manual override 43). Such a code has two functions—it allows, when desired, the “synching” of multiple strobe lights 30 to one smoke detector and/or override switch; it also prevents the inadvertent triggering of a neighbor's strobe light 30.

In an alternate embodiment, the wireless system as herebefore described can operate through the creation of a wireless local area network, or a conventional or customized WiFi signal using known WiFi communications protocols between the smoke detector 40, the receiving device 44, and optionally the manual override 43. For example, a local area wireless exchange of data between smoke detector 40 and receiving device 44 can be through the use of a 2.4 GHz UHF and/or 5 GHz SHF radio wave.

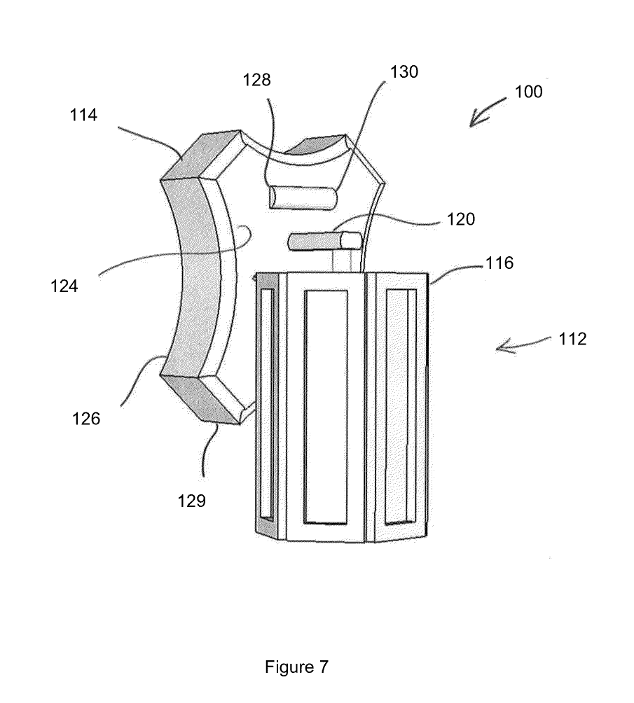

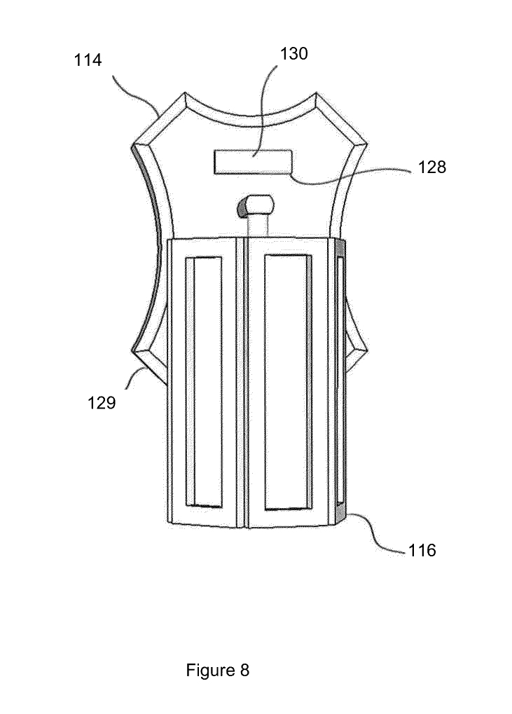

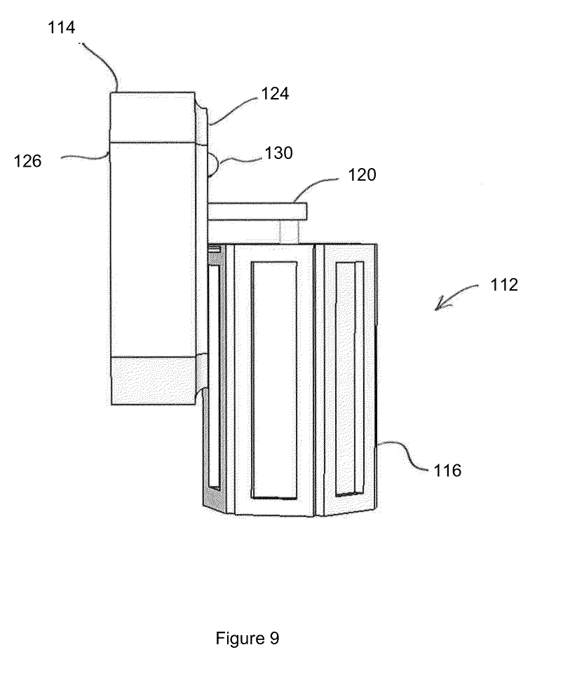

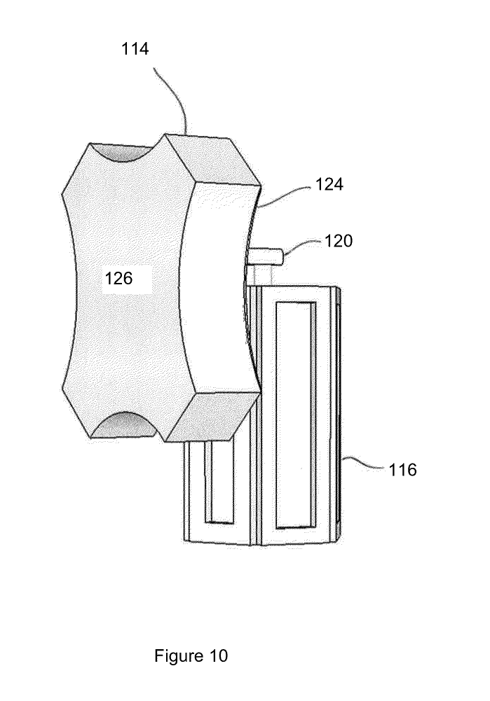

Referring now to FIGS. 7-10 an alternate exemplary embodiment of a porch light assembly 100 according to the present disclosure. In the subject example embodiment, the porch light assembly 100 comprises a lighting fixture 112 with an attached mounting base 114, the lighting fixture 112 being attached to the mounting base 114 by means of an intermediate mounting portion 120. In this embodiment, the attached mounting base 114 serves to mount the lighting fixture 112 to an exterior surface associated with the building or residence. Accordingly, lighting fixture 112 is attached to a first or front surface 124 of the mounting base 114 in accordance with any standard mounting arrangement as known in the art, the second or rear surface 126 of the mounting base 114 for mounting to any suitable the exterior wall or surface associated with the building or residence in accordance with any standard mounting principles known in the art, the features of which are not shown in the drawings for ease of illustration. An opening 128 is formed in the mounting base 114 for receiving a strobe light 130, the opening 128 extending through the mounting base 114 from the first surface 122 to the second 124. The opening 128 is positioned so as to be slightly spaced away from the lighting fixture 112 within the footprint or boundary defined by a peripheral edge 129 the mounting base 114. As shown in the drawings, the mounting base 114 can have any shape in order to correspond to the decorative nature of the lighting fixture 112, the opening 128 with strobe light 130 being positioned in an area on the mounting base 114 that is un-obscured by the lighting fixture 112 to ensure that the strobe light 130 is visible when the porch light assembly 100 is installed. As well, the lighting fixture 112 with attached mounting base 114 can be mounted exterior to the building or residence so that the strobe light 130 is positioned at the top of the mounting base 114 which is particular suitable when the lighting fixture 112 extends downwardly. Alternatively, if the lighting fixture 112 is to extend upwardly, the porch light assembly 100 can be rotated so that the strobe light 130 is arranged at the bottom of the mounting base 114, as shown in FIG. 10A. Accordingly, the porch light assembly 100 provides flexibility as to how the entire assembly 100 can be installed even when the mounting base 114 is integrally attached to the lighting fixture 112.

Since the mounting base 114 is part of the porch light assembly 100, any wiring or other electrical components associated with the lighting fixture 112 or the porch light 130 are accessible from the rear or second surface 126 of the mounting base 114, the features of which are not shown in the drawings for ease of illustration. Accordingly, the porch light assembly 114 can easily and conveniently be installed exterior to the building or residence. As with the previously described embodiment, the lighting fixture 112 with attached mounting base 114 can be connected to the electrical system of the building or residence with the strobe light 130 being hardwired into the same circuit that interconnects the one or more smoke detectors (or fire alarms) 40 within the building, the lighting fixture 112 being powered through a separate circuit so that the lighting fixture 112 and strobe light 130 can operate independently from each other, the strobe light 130 being activated when one or more of the fire alarms or smoke detectors 40 are activated within the building.

Alternatively, the porch light assembly 100 can be equipped with a wireless receiving device 44 that is electrically connected to the strobe light 130, the wireless receiving device 44 communicating with a corresponding transmitting device 46 associated with each of the respective smoke detectors (or fire alarms) 40 within the building or residence as previously described in connection with FIG. 15.

FIGS. 11-13 illustrate another exemplary embodiment of the porch light assembly 100 according to the present disclosure wherein the mounting base 114 and lighting fixture 112 have different decorative features and the strobe light 130 remains flush with the first or front surface 124 of the attached mounting base 114 rather than projecting out of the first surface 124 thereof as in the previously described embodiments. Accordingly, it will be understood that the porch light assembly 100 can be adapted to suit a variety of different designs and that any suitable porch light can be adapted to incorporate a strobe light 30, 130 into the attached mounting base 114.

FIGS. 16 and 17 show an additional front perspective view of the porch light assembly as shown in FIG. 4, shown in perspective to better show the configuration of the mounting base 14 as it relates to the electrical box 27. FIG. 16 shows the porch light assembly within the context of a wall; FIG. 17 shows the same assembly affixed to electrical box 27 shown in isolation of the wall in which electrical box 27 would reside.

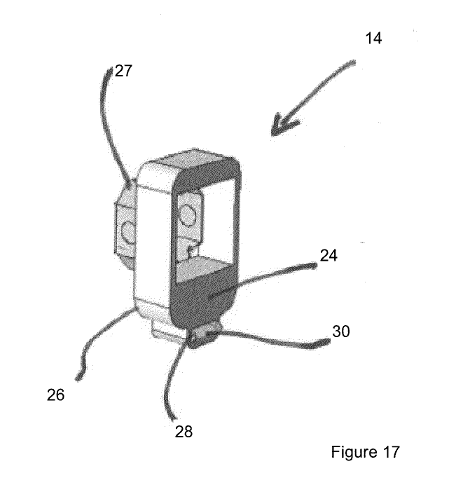

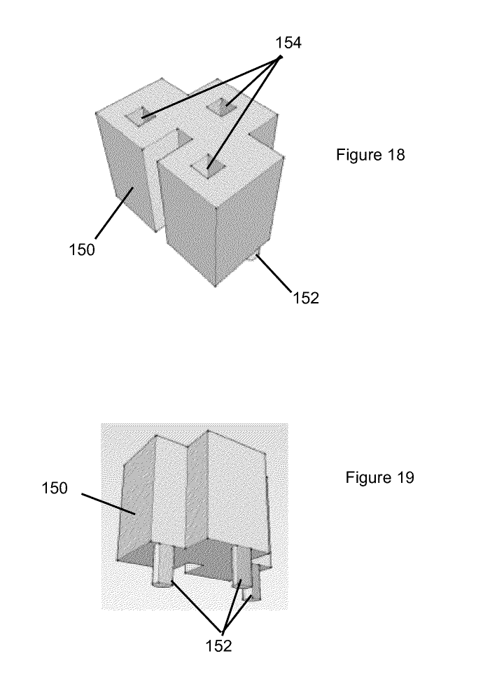

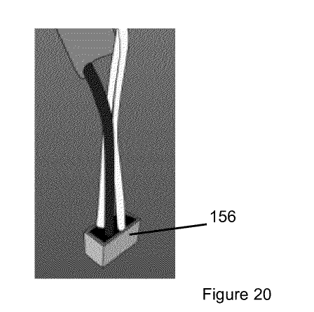

According to a further embodiment of the present invention, in the wireless configuration as shown schematically in FIG. 15, it is possible to “retrofit” a known prior art smoke detector for use in the invention. In such a configuration, the smoke detector 40 would not have an integrated transmitting device 46. Such smoke detectors can be retrofit by placing a retrofit unit 150 as shown in FIGS. 18 and 19 between the smoke detector 40 and the standard wiring harness for such smoke detectors (not shown). Retrofit unit 150 comprises a male connector 152 configured to plug into the wiring harness (not shown) into which a standard smoke detector 40 would normally plug into, and a female connector 154 configured to plug into a standard smoke detector where a wiring harness (not shown) would normally plug into. Retrofit unit 150 is of a size that it can easily fit into a standard electrical box onto which a smoke detector would normally be affixed. Retrofit unit 150 draws necessary power from the wiring harness and comprises transmitting device 46. Optionally, retrofit unit 150 may also contain a rechargeable battery, for allowing retrofit unit 150 to communicate with wireless receiving device 44 in situations where the wiring harness is not providing electrical power, for example, in the case of a blackout or a power failure in the building. Alternatively, a retrofit unit integrated into a wiring harness (retrofit harness 156) can be utilized, as illustrated in FIG. 20.

While exemplary embodiments of the porch light assembly have been described and shown in the drawings, it will be understood that certain adaptations and modifications of the described exemplary embodiments can be made as construed within the scope of the present disclosure. Therefore, the above described exemplary embodiments are considered to be illustrative and not restrictive.

What is claimed is:

1. A porch light assembly for mounting exterior to a building or residence having at least one smoke detector installed therein, the porch light assembly comprising:
a lighting fixture;
a mounting base having a first surface for receiving said lighting fixture and a second surface, the second surface being a mounting surface;
a strobe light mounted within said mounting base and visible from the first surface of said mounting base;
a first electrical connection for operating said lighting fixture; and
a second electrical connection for operating said strobe light;
wherein said second electrical connection is operably coupled to said at least one smoke detector, the strobe light being activated upon activation of said at least one smoke detector.

2. The porch light assembly as claimed in claim 1, wherein said mounting base is integral with said lighting fixture.

3. The porch light assembly as claimed in claim 1, wherein the mounting base is separate to said lighting fixture.

4. The porch light assembly as claimed in claim 3, wherein said lighting fixture comprises:
a decorative housing for housing a lighting device; and
a mounting portion, the mounting portion being attached to said first surface of said mounting base.

5. The porch light assembly as claimed in claim 1, wherein said mounting base comprises an opening for receiving said strobe light.

6. The porch light assembly as claimed in claim 1, further comprising:
a wireless receiving device electrically connected to said strobe light;
a transmitting device operably coupled to said at least one smoke detector for transmitting a signal upon activation of said smoke detector;
wherein said wireless receiving device is adapted for receiving said signal from said transmitting device, the strobe light being activated by said wireless receiving device upon receipt of said signal.

7. The porch light assembly as claimed in claim 6, wherein said wireless receiving device is battery powered.

8. The porch light assembly as claimed in claim 7, wherein said battery is a rechargeable battery adapted to receive a charge from said lighting fixture.

9. The porch light assembly as claimed in claim 1, further comprising a third electrical connection for operating said strobe light independent of said at least one smoke detector.

10. The porch light assembly as claimed in claim 1, further comprising a further switch, for wirelessly operating said strobe light independent of said at least one smoke detector.

11. A mounting base for a porch light having a lighting fixture and a mounting portion for use exterior to a building or residence having at least one smoke detector installed therein, the mounting base comprising:
a body having a first surface for receiving and engaging the mounting portion of said porch light and a second surface for mounting to a surface exterior to a building or residence;
a first opening formed in said body;
a second opening formed in said body;
a strobe light device mounted within said second opening and visible on said first surface;
an electrical box mounted within said first opening for receiving electrical components associated with said lighting fixture and said strobe light.

12. The mounting base as claimed in claim 11, wherein said second opening is formed in and extends away from a peripheral edge of said body.

13. The mounting base as claimed in claim 11, wherein said body has a peripheral edge defining a boundary of said mounting base, said second opening being formed within said boundary.

14. The mounting base as claimed in claim 11, further comprising a wireless receiving device operably connected to said strobe light, said wireless receiving device adapted to receive a signal from a corresponding smoke detector.

15. A kit for a porch light assembly with an emergency signaling device, comprising:
at least one smoke detector adapted for installation within a building or residence, or a retrofit kit or retrofit harness, adapted for installation to an existing smoke detector;
a mounting base having a first surface for receiving a lighting fixture and a second mounting surface;
a strobe light mounted within said mounting base and visible from the first surface;
wherein the mounting base provides a first electrical connection in communication with said lighting fixture, said first electrical connection adapted to connect to an electrical system within said building or residence;
and a second electrical connection in communication with said at least one smoke detector or retrofit kit and operably coupled to said strobe light.

16. The kit as claimed in claim 15, further comprising:
a wireless receiving device mounted within said mounting base and coupled to said strobe light; and
a transmitting device mounted to said at least one smoke detector or said retrofit kit and adapted for communication with said wireless receiving device.

17. The kit as claimed in claim 15, wherein said lighting fixture is integral with said mounting base.

18. The kit as claimed in claim 15, wherein said mounting base comprises:
a body defining said first surface and said second surface;
a first opening formed in said body;
a second opening formed in said body;
a strobe light device mounted within said second opening and visible on said first surface;
an electrical box mounted within said first opening for receiving electrical components associated with said lighting fixture and said strobe light;
wherein said second opening is formed within and extends away from a peripheral edge of the body, the first surface adapted to receive a mounting portion of any corresponding lighting fixture, the mounting portion of the lighting fixture closing said first opening.

19. A system for identifying a building or residence in need of emergency assistance, comprising:
at least one smoke detector operably installed within a building or residence;
an exterior porch light assembly mounted exterior to and in relation to said building or residence;
a strobe light device connected to said exterior porch light, the strobe light device being operably coupled to said at least one smoke detector, the strobe light being activated simultaneously upon activation of said at least one smoke detector.

20. The system as claimed in claim 19, wherein said strobe light is operably coupled to said at least one smoke detector by means of a wireless connection.

21. The system as claimed in claim 19, wherein said at least one smoke detector is one of a plurality of smoke detectors operably installed with said building or residence, said plurality of smoke detectors being hardwired to an electrical circuit within an electrical system of said building or residence; and wherein said strobe light device is hardwired to the electrical circuit associated with said plurality of smoke detectors, the strobe light device being activated simultaneously with one or more of said plurality of smoke detectors.
